(19) United States
(12) Patent Application Publication
(10) Pub. No.: US 2003/0092822 A1
(43) Pub. Date: May 15, 2003

(54) Highly viscous polyamide for use in extrusion blow molding

(76) Inventors: Detlev Joachimi, Krefeld (DE); Helmut Schulte, Krefeld (DE); Wolfram Littek, Solingen (DE); Jurgen Kadelka, Krefeld (DE)

Correspondence Address: BAYER CORPORATION, PATENT DEPARTMENT, 100 BAYER ROAD, PITTSBURGH, PA, 15205, US

(21) Appl. No.: 10/220,771

(22) PCT Filed: Feb. 26, 2001
(86) PCT No.: PCT/EP01/02211

(30) Foreign Application Priority Data
Mar. 9, 2000 (DE) 100 11 128.9
Apr. 25, 2000 (DE) 100 20 164.4
Aug. 28, 2000 (DE) 100 42 176.8

(51) Int. Cl. C08K 3/40

(52) U.S. Cl. 524/494

(57) ABSTRACT

The invention relates to thermoplastic molding materials that are produced from a mixture containing an aliphatic polyanmide and/or copolyamide, fillers and reinforcement agents, bifunctional or multifunctional additives that induce branching and/or polymer chain extension, a modifier and other additives that do not induce branching and/or polymer chain extension.

The invention relates to thermoplastic moulding compositions, produced from a mixture containing aliphatic polyamide and/or copolyamide, fillers and reinforcing materials, di- or polyfunctional additives with branching and/or polymer chain extending action, modifier and other non-branching and non-polymer chain extending additives.

Extrusion blow-mouldable, glass fibre-reinforced polyamide 66 exhibiting processability and hydrolysis stability which would be suitable for hollow articles in a cooling circuit, has been unknown up to the present. Some blow-mouldable PP is used, but its hydrolysis resistance/heat resistance is unsatisfactory. Blow-mouldable grades of PA are, in most cases, based on PA6, which is less suitable than PA66 for applications in contact with cooling medium (EP-B 0 868 499). To assess hydrolysis resistance, standardised test pieces (e.g. tensile specimens or bars 80×10×4 nm³) are usually stored in cooling medium (e.g. in ethylene glycol/water 1/1 at 130° C./2 bar in an autoclave) and subjected to mechanical tests (tensile test, flexural test, flexural impact test) after specific intervals.

Suitability for extrusion blow moulding requires the highest possible viscosity with a low shear rate. Such high viscosities can be achieved with glass fibre-reinforced PA66, e.g. by solid phase post-condensation of linear PA66 compounds, i.e. a medium-viscosity PA66 is compounded with e.g. 25% glass fibres on a twin screw extruder and the granules obtained are then subjected to post-condensation in the solid phase. This can take place e.g. in a vacuum tumble drier or in a continuous inert gas drier under conditions with which the person skilled in the art is familiar. The use of high-viscosity, unreinforced PA66 as the base resin in the compounding does not normally lead to the high-viscosity materials desired, since degradation of the molecular weight, and thus reduction of the viscosity, occurs as a result of the high shear forces and temperatures in the extruder.

Another way of obtaining high-viscosity PA66 is to incorporate long-chain branching by reactive extrusion, e.g. as described for glass fibre-reinforced PA6 in EP-A 685 528.

While it is true that the transfer of this method of branching using bisphenol A diglycidyl ether or with similar branching agents to glass fibre-reinforced PA66 also leads to high-viscosity, extrudable PA66, however, the surface quality and pinch-off weld strength of hollow articles extrusion blow moulded from such compounds are inadequate for most technically relevant applications.

The assessment of extrusion blow mouldability on the basis of material properties is usually only possible to a limited extent. Extrusion tests in which molten tubes are extruded vertically downwards from an annular die under constant conditions, and the drawdown of the molten tubes is observed, are considerably closer to actual practice. Extrusion is carried out continuously and the time taken for the molten tube to achieve a predetermined length is evaluated, or extrusion is carried out for separate periods and the drawdown of the tube sections is observed as the time intervals become longer. In both cases, the length that the tube would be under ideal conditions, without drawdown or shrinkage, is the basis of comparison.

For the manufacture of hollow articles by the extrusion blow moulding process, an extrusion blow-mouldable, glass fibre-reinforced PA66 was to be provided which is suitable for applications in motor vehicle cooling circuits through combining good resistance to cooling media (e.g. ethylene glycol/water 1/1) with good surface quality.

Surprisingly, it has been found that high-viscosity, glass fibre-reinforced compounds with good hydrolysis resistance and good surface quality can be obtained by compounding medium-viscosity PA66 with glass fibres, adding branching agents/chain extenders (e.g. bisphenol A diglycidyl ether) in the presence of small quantities of elastomer modifiers, optionally in the presence of crystallisation-inhibiting additives. The viscosity of the material obtained is so high that very good processability by the blow moulding method can be achieved, and no solid phase post-condensation is necessary. The compounds have good resistance to cooling medium, e.g. ethylene glycol/water, even at 130° C.

The application provides mixtures containing 40 to 89.9 parts by weight of one or more aliphatic polyamides or copolyamides with 10 to 50 parts by weight of fillers and reinforcing materials, preferably glass fibres, 0.05 to 3 parts by weight of di- or polyfunctional additives with a branching and/or polymer chain extending action, 0.05 to 5 parts by weight of modifier and 0 to 5 parts by weight of other non-branching and non-polymer chain extending additives, the sum of the parts by weight totalling 100.

The application also provides thermoplastic moulding compositions produced from this mixture.

Suitable polyamides are known homopolyamides, copolyamides and mixtures of these polyamides. These can be partially crystalline and/or amorphous polyamides.

Suitable partially crystalline polyamides are polyamide-6, polyamide-6,6, mixtures and appropriate copolymers of these components. Polyamides, the acid component of which consists wholly or partly of terephthalic acid and/or isophthalic acid and/or suberic acid and/or sebacic acid and/or azelaic acid and/or adipic acid and/or cyclohexanedicarboxylic acid, the diamine component of which consists wholly or partly of m- and/or p-xylylenediamine and/or hexamethylenediarnine and/or 2,2,4-trimethylhexamethylenediamine and/or 2,4,4-trimethylhexamethylenediamine and/or isophorone diamine and the composition of which is known in principle, are also suitable.

In addition, polyamides which are produced wholly or partly from lactams with 7-12 C atoms in the ring, optionally incorporating one or more of the above-mentioned starting components, should also be mentioned.

Polyamide-6,6 is particularly preferred. Known products can be used as amorphous polyamides. They are obtained by polycondensation of diamines such as ethylene-diamine, hexamethylenediamine, decamethylenediamine, 2,2,4- and/or 2,4,4-trimethylhexamethylenediamine, m- and/or p-xylylenediamine, bis (4-aminocyclohexyl)methane, bis(4-aminocyclohexyl)propane, 3,3′-dimethyl-4,4′-diaminodicyclohexylmethane, 3-aminomethyl-3,5,5-trimethylcyclohexylamine, 2,5- and/or 2,6-bis(aminomethyl)norbomane and/or 1,4-diaminomethylcyclohexane with dicarboxylic acids such as oxalic acid, adipic acid, azelaic acid, decanedicarboxylic acid, heptadecanedicarboxylic acid 2,2,4- and/or 2,4,4-trimethyladipic acid, isophthalic acid and terephthalic acid.

Copolymers obtained by the polycondensation of several monomers are also suitable, as are copolymers produced with the addition of aminocarboxylic acids such as -aminocaproic acid, -aminoundecanoic acid or -aminolauric acid or the lactams thereof.

The polyamides preferably have a relative viscosity (measured on a 1 wt. % solution in m-cresol at 25° C.) of 2.3 to 4.0, particularly preferably of 2.7 to 3.5.

The moulding compositions according to the invention can contain other, non-branching and non-polymer chain extending additives such as colorants, stabilisers (especially copper-containing stabilisers), lubricants and processing aids and optionally, other additives.

Preferred other additives which are suitable for modifying the high-viscosity polyamides are:

waxes (e.g. polyethylene waxes, montanic acid esters, amide waxes)

other salts of long-chain carboxylic acids (e.g. stearates and palmitates with calcium, lithium or sodium as counterion)

nucleating agents (e.g. microtalc, barium sulfate, calcium fluoride, phenyl phosphinate, lithium chloride etc.)

stabilisers which contain copper species (e.g. Cul/potassium halide mixtures, Cu acetate, stearate and/or complexes with Cu as the central atom; also combinations of Cu(0) with Cu salts and alkali halides)

stabilisers of the phenolic antioxidants, phosphates, sterically hindered amines (HALS) or benzophenones type

colorants (e.g. organic and inorganic pigments and/or dyes; carbon black, titanium dioxide)

polyether glycols or derivatives of polyether glycols which are derived from substituted ethylene glycol or compounds of ethylene glycol or polyethylene glycol,

it being possible to use these additives alone or in combination, optionally in the form of masterbatches or powder mixtures, including in compacted or granulated form.

The polyamides can additionally contain other fibrous reinforcing materials and/or mineral fillers. Apart from glass fibres, carbon fibres, aramid fibres, mineral fibres and whiskers are suitable as fibrous reinforcing materials. Calcium carbonate, dolomite, calcium sulfate, mica, fluoromica, wollastonite, talcum and kaolin can be mentioned as examples of suitable mineral fillers. However, other oxides or hydrated oxides of an element selected from the group of boron, aluminium, gallium, indium, silicon, tin, titanium, zirconium, zinc, yttrium or iron can also be used. To improve the mechanical properties, the fibrous reinforcing materials and the mineral fillers can be surface-treated.

Glass Fibres are Preferred.

The fillers can be added before, during or after the polymerisation of the monomers to the polyamide. If the fillers according to the invention are added after the polymerisation, this is preferably accomplished by adding them to the polyamide melt in an extruder. If the fillers according to the invention are added before or during the polymerisation, the polymerisation can comprise phases in which work is carried out in the presence of 1 to 50 wt. % water.

When the fillers are added they can already be present as particles with the particle size ultimately occurring in the moulding composition. Alternatively, the fillers can be added in the form of preliminary stages from which the particles ultimately occurring in the moulding composition are produced only in the course of the addition or incorporation. These preliminary stages can contain auxiliaries which are used e.g. to stabilise the preliminary stage or to ensure that the particles are finely dispersed in the moulding composition. Such auxiliaries can, for example, be surface modifiers.

In addition to or instead of glass fibres, C fibres, aramid fibres, mineral fillers or reinforcing materials and similar materials can be considered as reinforcing materials. These can optionally be provided with surface modifications, e.g. silanes or glass fibre sizes. The total solids content of the fillers and reinforcing materials is preferably between 10 and 50 wt. % and particularly preferably between 12 and 35 wt. %, based on the moulding composition.

In principal, all types that can also be used otherwise in PA66 are suitable as modifiers, preferably elastomer modifiers. The additional use of rubber-elastic polymers (often also referred to as impact modifier, elastomer or rubber) is particularly preferred.

In general, these are copolymers (with the exception of copolyamides) which are preferably built up from at least two of the following monomers: ethylene, propylene, butadiene, isobutene, isoprene, chloroprene, vinyl acetate, styrene, acrylonitrile and acrylates or methacrylates with 1 to 18 C atoms in the alcohol component.

Polymers of this kind are described e.g. in Houben-Weyl, Methoden der organischen Chemie, vol. 14/1 (Georg-Thieme-Verlag, Stuttgart, 1961), pages 392 to 406 and in the monograph by C. B. Bucknall, “Toughened Plastics” (Applied Science Publishers, London, 1977).

Several preferred types of these elastomers are presented below.

Preferred types of these elastomers are the so-called ethylene-propylene (EPM) or ethylene-propylene-diene (EPDM) rubbers.

In general, EPM rubbers have virtually no double bonds any longer, while EPDM rubbers can have 1 to 20 double bonds per 100 C atoms.

Conjugated dienes such as isoprene and butadiene, unconjugated dienes with 5 to 25 C atoms such as 1,4-pentadiene, 1,4-hexadiene, 1,5-hexadiene, 2,5-dimethyl-1,5-hexadiene and 1,4-octadiene, cyclic dienes such as cyclopentadiene, cyclohexadienes, cyclooctadienes and dicyclopentadiene, and alkenyl norbomenes such as 5-ethylidene-2-norbomene, 5-butylidene-2-norbomene, 2-methallyl-5-norbomene, 2-isopropenyl-5-norbomene and tricyclodienes such as 3-methyltricyclo-(5.2.1.0.2.6)-3,8-decadiene or mixtures thereof can be mentioned as examples of diene monomers for EPDM rubbers. 1,5-Hexadiene, 5-ethylidenenorbomene and dicyclopentadiene are preferred. The diene content of the EPDM rubbers is preferably 0.5 to 50, especially 1 to 8 wt. %, based on the total weight of the rubber.

EPM or EPDM rubbers can preferably also be grafted with reactive carboxylic acids or derivatives thereof. Acrylic acid, methacrylic acid and derivatives thereof, e.g. glycidyl (meth)acrylate, and maleic anhydride, can be mentioned as examples.

Copolymers of ethylene with acrylic acid and/or methacrylic acid and/or with the esters of these acids are another group of preferred rubbers. In addition, the rubbers can also contain dicarboxylic acids, such as maleic acid and fumaric acid or derivatives of these acids, e.g. esters and anhydrides, and/or epoxy group-containing monomers. These dicarboxylic acid derivatives or epoxy group-containing monomers are preferably incorporated into the rubber by the addition of dicarboxylic acid- or epoxy group-containing monomers of the general formulae (I) or (II) or (III) or (I) to the monomer mixture,

R¹C(COOR²)═C(COOR³)R⁴ (I)

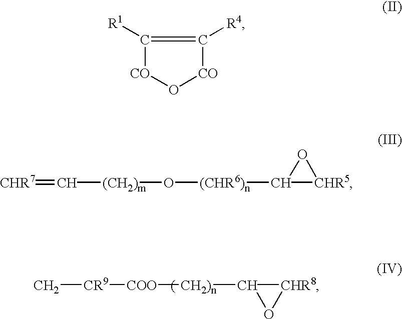

wherein R¹ to R⁹ represent hydrogen or alkyl groups with 1 to 6 C atoms, m is an integer from 0 to 20, and n is an integer from 0 to 10.

The radicals R¹ to R⁹ preferably signify hydrogen, m denoting 0 or 1 and n denoting 1. The corresponding compounds are maleic acid, fumaric acid, maleic anhydride, allyl glycidyl ether and vinyl glycidyl ether.

Preferred compounds of formulae (I), (II) and (IV) are maleic acid, maleic anhydride and epoxy group-containing esters of acrylic acid and/or methacrylic acid, such as glycidyl acrylate, glycidyl methacrylate and the esters with tertiary alcohols such as t-butyl acrylate. While it is true that the latter have no free carboxyl groups, they resemble the free acids in their behaviour and are therefore referred to as monomers with latent carboxyl groups.

The copolymers advantageously consist of 50 to 98 wt. % ethylene, 0.1 to 20 wt. % epoxy group-containing monomers and/or methacrylic acid and/or acid anhydride group-containing monomers and the remaining quantity of (meth)acrylates.

Copolymers of

50 to 98, especially 55 to 95 wt. % ethylene,

0.1 to 40, especially 0.3 to 20 wt. % glycidyl acrylate and/or glycidyl methacrylate, (meth)acrylic acid and/or maleic anhydride, and

1 to 45, especially 10 to 40 wt. % n-butyl acrylate and/or 2-ethylhexyl acrylate,

are particularly preferred.

Other preferred esters of acrylic and/or methacrylic acid are the methyl, ethyl, propyl and i- or t-butyl esters.

In addition, vinyl esters and vinyl ethers can also be used as comonomers.

The ethylene copolymers described above can be produced by processes which are known per se, preferably by random copolymerisation under high pressure and elevated temperature. Suitable processes are generally known.

Preferred elastomers are also emulsion polymers, the production of which is described e.g. by Blackley in the monograph “Emulsion Polymerisation”. The emulsifiers and catalysts that can be used are known per se.

In principle, homogeneously built up elastomers or those with a shell-type construction can be used. The shell-type construction is determined by the order in which the individual monomers are added; the morphology of the polymers is also influenced by this order of addition.

Acrylates, such as e.g. n-butyl acrylate and 2-ethylhexyl acrylate, corresponding methacrylates, butadiene and isoprene, and mixtures thereof, are mentioned here only as representative examples of monomers for producing the rubber part of the elastomers. These monomers can be copolymerised with other monomers, such as e.g. styrene, acrylonitrile, vinyl ethers and other acrylates or methacrylates, such as methyl methacrylate, methyl acrylate, ethyl acrylate and propyl acrylate.

The soft or rubber phase (with a glass transition temperature of less than 0° C.) of the elastomers can represent the core, the outer shell or an intermediate shell (in elastomers built up of more than two shells); in the case of multi-shell elastomers, it is also possible for more than one shell to consist of a rubber phase.

If, in addition to the rubber phase, one or more hard components (with glass transition temperatures of more than 20° C.) are involved in the construction of the elastomer, these are generally produced by the polymerisation of styrene, acrylonitrile, methacrylonitrile, x-methylstyrene, p-methylstyrene, acrylates and methacrylates such as methyl acrylate, ethyl acrylate and methyl methacrylate as the main monomers. In addition, small portions of other comonomers can also be used here.

In some cases, it has proved advantageous to use emulsion polymers exhibiting reactive groups at the surface. Such groups are e.g. epoxy, carboxyl, latent carboxyl, amino or amide groups and functional groups which can be introduced by the joint use of monomers of the general formula

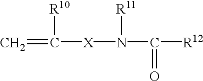

wherein the substituents can have the following meaning:

R¹⁰ hydrogen or a C₁ to C₄ alkyl group,

R¹¹ hydrogen, a C₁ to C₈ alkyl group or an aryl group, especially phenyl,

R¹² hydrogen, a C₁ to C₁₀ alkyl, a C₆ to C₁₂ aryl group or -OR¹³,

R¹³ a C₁ to C₈ alkyl or C₆ to C₁₂ aryl group, which can optionally be substituted with O- or N-containing groups,

X a chemical bond, a C₁ to C₁₀ alkylene, a C₆ to C₁₂ arylene group or

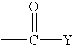

Y O-Z or NH-Z and

Z a C₁ to C₁₀ alkylene or a C₆ to C₁₂ arylene group.

The graft monomers described in EP-A 208 187 are also suitable for the introduction of reactive groups to the surface.

Acrylamide, methacrylamide and substituted esters of acrylic acid or methacrylic acid such as (N-t-butylamino)ethyl methacrylate, (N,N-dimethylamino)ethyl acrylate, (N,N-dimethylamino)methyl acrylate and (N,N-diethylamino)ethyl acrylate can also be mentioned as further examples.

Furthermore, the particles of the rubber phase can also be crosslinked. Monomers with crosslinking action are, for example, 1,3-butadiene, divinylbenzene, diallyl phthalate and dihydrodicyclopentadienyl acrylate and the compounds described in EP-A 50 265.

In addition, so-called graft linking monomers can also be used, i.e. monomers with two or more polymerisable double bonds which react at different rates during polymerisation. Those compounds in which at least one reactive group polymerises at about the same rate as the other monomers, while the other reactive group (or reactive groups) e.g. polymerise(s) significantly more slowly, are preferably used. The different rates of polymerisation entail a certain proportion of unsaturated double bonds in the rubber. If a further phase is subsequently grafted on to such a rubber, the double bonds present in the rubber react at least partially with the graft monomers to form chemical bonds, i.e. the grafted phase is at least partially linked with the grafting backbone by means of chemical bonds.

Examples of these graftlinking monomers are allyl group-containing monomers, especially allyl esters of ethylenically unsaturated carboxylic acids, such as allyl acrylate, allyl methacrylate, diallyl maleate, diallyl fumarate, diallyl itaconate or the corresponding monoallyl compounds of these dicarboxylic acids. In addition, there are many other suitable graftlking monomers; for further details of these, refer, for example, to U.S. Pat. Nos. 4,148,846 and 4,327,201.

A few preferred emulsion polymers are listed below. Graft copolymers with a core and at least one outer shell should be mentioned first, having the following construction:

| Type | Monomers for the core | Monomers for the shell |
|---|---|---|
| I | 1,3-butadiene, isoprene, n-butyl | styrene, acrylonitrile, methyl |
| | acrylate, ethylhexyl acrylate or | methacrylate |
| | mixtures thereof | |
| II | as I, but incorporating crosslinking | as I |
| | agents | |
| III | as I or II | n-butyl acrylate, |
| | | ethyl acrylate, |
| | | methyl acrylate, 1,3-butadiene |
| | | isoprene, ethylhexyl acrylate |
| IV | as I or II | as I or III, but incorporating |
| | | monomers with |
| | | reactive groups as |
| | | described herein |
| V | styrene, acrylonitrile, methyl | first shell of |
| | methacrylate or mixtures thereof | monomers as described |
| | | in I and II for the core |
| | | second shell as |
| | | described in I or IV |
| | | for the shell |

Instead of graft copolymers with a multi-shell construction, homogeneous, i.e. single-shell elastomers of 1,3-butadiene, isoprene and n-butyl acrylate or copolymers thereof can also be used. These products can also be produced by incorporating crosslinking monomers or monomers with reactive groups.

Examples of preferred emulsion polymers are n-butyl acrylate/(meth)acrylic acid copolymers, n-butyl acrylate/glycidyl acrylate or n-butyl acrylate/glycidyl methacrylate copolymers, graft copolymers with an inner core of n-butyl acrylate or based on butadiene and an outer shell of the above-mentioned copolymers and copolymers of ethylene with comonomers which provide reactive groups.

The elastomers described can also be produced by other conventional processes, e.g. by suspension polymerisation.

Silicone rubbers, as described in DE-A 37 25 576, EP-A 235 690, DE-A 38 00 603 and EP-A 319 290, are also preferred.

Mixtures of the rubber types listed above can, of course, also be used.

Elastomer modifiers of the EPM, EPDM and acrylate type are particularly preferred.

Suitable as branching agents or chain extenders are low molecular-weight and oligomeric compounds having at least two reactive groups which can react with primary and/or secondary amino groups, and/or amide groups and/or carboxylic acid groups. Reactive groups can be e.g. isocyanates, optionally blocked, epoxides, maleic anhydride, oxazolines, oxazines, oxazolones i.a. Diepoxides based on diglycidyl ether (bisphenol and epichlorohydrin), based on aminoepoxy resin (aniline and epichlorohydrin) and based on diglycidyl ester (cycloaliphatic dicarboxylic acids and epichlorohydrin) are preferred, individually or in mixtures, and also 2,2-bis[p-hydroxyphenyl]propane diglycidyl ether and bis[p-(N-methyl-N-2,3-epoxypropyl-amino)phenyl]methane. Glycidyl ethers are particularly preferred and bisphenol A diglycidyl ether is quite particularly preferred.

The following are suitable for branching/chain extending:

1. Polyglycidyl or oligoglycidyl or poly(β-methylglycidyl)ethers obtainable by reacting a compound having at least two free alcoholic hydroxy groups and/or phenolic hydroxy groups and a suitably substituted epichlorohydrin under alkaline conditions, or in the presence of an acidic catalyst with subsequent alkali treatment.

Ethers of this type are derived e.g. from acyclic alcohols such as ethylene glycol, diethylene glycol and higher poly(oxyethylene) glycols, 1,2-propanediol or poly(oxypropylene) glycols, 1,3-propanediol, 1,4-butanediol, poly (oxytetra-methylene) glycols, 1,5-pentanediol, 1,6-hexanediol, 2,4,6-hexanetriol, glycerol, 1,1,1-trimethylpropane, bistrimethylolpropane, pentaerythritol, sorbitol and from polyepichlorohydrins.

However, they can also be derived e.g. from cycloaliphatic alcohols such as 1,3- or 1,4-dihydroxycyclohexane, bis(4-hydroxycyclohexyl)methane, 2,2-bis(4-hydroxycyclohexyl)propane or 1,1-bis(hydroxymethyl)-3-cyclohexene or they possess aromatic rings such as N,N-bis-(2-hydroxyethyl)aniline or p,p′-bis(2-hydroxyethylamino)diphenylmethane.

The epoxy compounds can also be derived from mononuclear phenols, such as e.g. from resorcinol or hydroquinone; or they are based on polynuclear phenols, such as e.g. on bis(4-hydroxyphenyl)methane, 2,2-bis(4-hydroxyphenyl)propane, 2,2-bis(3,5-dibromo-4-hydroxyphenyl)propane, 4,4′-dihydroxydiphenyl sulfone or on condensation products of phenols with formaldehyde obtained under acidic conditions, such as phenol novolaks.

2. Poly- or oligo(N-glycidyl) compounds obtainable by dehydrochlorination of the reaction products of epichlorohydrin with amines containing at least two amino hydrogen atoms. These amines are, for example, aniline, toluidine, n-butylamine, bis(4-aminophenyl)methane, m-xylylenediamine or bis(4-methylaminophenyl)methane, but also N,N,O-triglycidyl-m-aminophenyl or N,N,O-triglycidyl-p-aminophenol.

However, the poly(N-glycidyl) compounds also include N,N′-diglycidyl derivatives of cycloalkylene ureas, such as ethyleneurea or 1,3-propyleneurea and N,N′-diglycidyl derivatives of hydantoins, such as of 5,5-dimethylhydantoin.

3. Poly- or oligo(S-glycidyl) compounds, such as e.g. di-S-glycidyl derivatives derived from dithiols, such as e.g. 1,2-ethanedithiol or bis(4-mercapto-methylphenyl)ether.

The application provides moulding compositions according to the invention, produced by melt compounding. The preferred subject-matter of the application is moulding compositions according to the invention in which PA 6,6 is used as the polyamide.

Thermoplastic moulding compositions wherein 60 to 84.9 parts by weight of PA66 with 15 to 39.9 parts by weight of glass fibres, 0.05-2 parts by weight of di- or polyfunctional additives with branching and/or polymer chain extending action, 0.05-3 parts by weight of modifier and 0 to 5 parts by weight of other additives, are used, are also preferred.

The application also provides the use of the moulding compositions according to the invention for the production of mouldings. Preferred processing methods are injection moulding, profile extrusion and blow moulding, with the standard extrusion blow moulding, 3D extrusion blow moulding and suction blow moulding being particularly preferably understood by blow moulding. The application also provides mouldings produced from the moulding compositions according to the invention. Mouldings according to the invention are, for example: radiator pipes, radiator headers, expansion tanks and pipes and containers carrying other media.

### EXAMPLES

The compounds according to the invention and those described in the comparative examples were produced using a ZSK 32 twin screw extruder from Werner & Pfleiderer under the compounding conditions conventional for glass fibre-reinforced PA 66. The bisphenol A diepoxide was metered into the PA melt using a liquid metering pump. The granules obtained were dried to a residual moisture content of less than 0.06% before further processing and then extruded into test pieces under conditions conventional for moulding composition, or used for viscosity measurements or extrusion blow moulding tests. The resistance to cooling medium (ethylene glycol/water 1/1) was tested by storing injection-moulded bars 80×10×4 mm³ in the cooling medium in an autoclave, followed by a flexural impact test (Izod impact strength) or flexural test. This storage always took place at 130° C./2 bar. At the end of the planned storage period at 130° C. the test pieces were cooled to ambient temperature in the autoclave for approx. 12 h, rinsed with water, freed of surface moisture and immediately measured.

The drawdown behaviour during tube extrusion was investigated using a Kripp-Kautex KEB 4/13 type extruder with a 60 mm screw diameter, 25 D, diversion head, mandrel/die diameter 40/44 mm. The following heating zone settings [° C.] were selected:

| Zone | Zone | Zone | Zone | Zone | | | Head | Head |
|---|---|---|---|---|---|---|---|---|
| 1 | 2 | 3 | 4 | 5 | Flange | Diversion | top | bottom |
| 280 | 300 | 300 | 270 | 270 | 275 | 260 | 260 | 260 |

The screw speed was 15 rpm and the output approx. 20 kg/h.

The compositions of the examples according to the invention and the comparative examples are given in table 1; properties in table 2.

The effect according to the invention becomes clear from table 2:

Moulding compositions according to the invention (examples 4 and 5) display excellent melt stability, pinch-off weld and surface quality, low roughness, high surface gloss and at the same time very good hydrolysis resistances.

TABLE 1
Compositions in wt. %

| | Example | Example | Example | | | Example |
|---|---|---|---|---|---|---|
| | 1 | 2 | 3 | | | 6 |
| | Compara- | Compara- | Compara- | | | Compara- |
| | tive | tive | tive | Example | Example | tive |
| | example | example | example | 4 | 5 | example |
| PA 6¹⁾ | | | 69.21 | | | |
| PA 66¹⁾ | | | | 72.76 | 72.76 | 73.96 |
| Glass fibres²⁾ | | | 30 | 25 | 25 | 25 |
| Carbon black | | | 0.16⁶⁾ | 0.16⁶⁾ | 0.16⁶⁾ | 0.16⁶⁾ |
| Licowax E | | | | 0.25 | 0.25 | 0.25 |
| FL³⁾ | | | | | | |
| Nigrosin⁷⁾ | | | | 0.2 | 0.2 | |
| CuI/KBr, | | | 0.13 | 0.13 | 0.13 | 0.13 |
| (1/2.8;g/g) | | | | | | |
| Bisphenol A | | | 0.5 | 0.5 | 0.5 | 0.5 |
| diglycidyl | | | | | | |
| ether⁹⁾ | | | | | | |
| Modifier | | | | 1⁸⁾ | 1¹⁰⁾ | |
| PA66 GF25⁴⁾ | 100 | | | | | |
| injection | | | | | | |
| moulding | | | | | | |
| grade | | | | | | |
| PA66 GF25⁵⁾ | | 100 | | | | |
| extrusion | | | | | | |
| grade | | | | | | |

¹⁾Medium-viscosity grades; relative solution viscosity in m-cresol 3.0
²⁾Diameter preferably 10-11 μm, e.g. PPG 3660, Vetrotex P 955, Bayer CS 7928
³⁾Montan ester wax from Clariant
⁴⁾E.g. Durethan AKV 25 H2.0 9005/0, commercial product from Bayer AG
⁵⁾E.g. Durethan KU 2-2228 9005/0, experimental product from Bayer AG; PA66GF25 condensed by solid phase post-condensation to a relative solution viscosity in m-cresol of approx. 4.0; without elastomer modifier
⁶⁾Printex 300, carbon black from DEGUSSA
⁷⁾Nigrosin, Colour Index Solvent Black 7
⁸⁾Exxelor VA 1801, EPM rubber from EXXON
⁹⁾Rütapox 0162, bisphenol A diglycidyl ether, Bakelite AG
¹⁰⁾Metablen P 550 SD; copolymer of PMMA and other acrylates, product of the Metablen Company B.V. (NL)

TABLE 2
Properties

| | | Example | | Example | | | Example |
|---|---|---|---|---|---|---|---|
| | | 1 | Example 2 | 3 | | | 6 |
| | | Compara- | Compara- | Compara- | | | Compara- |
| | | tive | tive | tive | Example | Example | tive |
| | | example | example | example | 4 | 5 | example |
| Relative | | 3.1 | 4.15 | 3.7 | 3.9 | 4.0 | 3.9 |
| solution | | | | | | | |
| viscosity in m- | | | | | | | |
| cresol | | | | | | | |
| MVR 290° C./ | cm³/min | 36 | 11 | 2.2¹⁾ | 3 | 3 | 4.4 |
| 5 kg | | | | | | | |
| Melt viscosity | Pa.s | 1300 | 1700 | 5200¹⁾ | 2800 | 2900 | 2300 |
| (at 290° C. | | | | | | | |
| shear rate 10/s) | | | | | | | |
| Melt stability²⁾ | | 5 | 4 | 1 | 1 | 1 | 2 |
| Pinch-off weld | | n.m.⁶⁾ | n.m.⁶⁾ | ⁹⁾ | 1 | 1 | 5 |
| quality⁵⁾ | | | | | | | |
| Surface | | n.m.⁶⁾ | n.m.⁶⁾ | ⁹⁾ | 1 | 2 | 4 |
| quality⁷⁾ | | | | | | | |
| Average | | | | | | | |
| roughness | | | | | | | |
| (Ra)¹⁰⁾ | | | | | | | |
| internal | μm | — | — | — | 17.59 | 20.49 | 34.25 |
| external | μm | — | — | — | 10.05 | 13.23 | 15.46 |
| Maximum | | | | | | | |
| roughness | | | | | | | |
| (TIR)¹⁰⁾ | | | | | | | |
| internal | μm | — | — | — | 130.70 | 94.14 | 208.7 |
| external | μm | — | — | — | 64.39 | 74.32 | 112.6 |
| Surface gloss⁸⁾ | | n.m.⁶⁾ | n.m.⁶⁾ | | 4.1 | 4.4 | 2.0 |
| Angle of | | | | | | | |
| measurement | | | | | | | |
| 60° | | | | | | | |
| Hydrolysis | kJ/m² | 6 | 7 | n.m.⁴⁾ | 17 | 15 | 12 |
| resistance³⁾ | | | | | | | |
| Impact | | | | | | | |
| strength (ISO | | | | | | | |
| 180 1C) | | | | | | | |
| Hydrolysis | MPa | 2050 | 2100 | n.m⁴⁾ | 2160 | 2100 | 2200 |
| resistance³⁾ | | | | | | | |
| Flexural | | | | | | | |
| modulus | | | | | | | |

¹⁾260° C.
²⁾Evaluated by the German schools' system of marking: 1 . . . very good, 6 . . . unsatisfactory
³⁾Measured on an injection-moulded test piece 80 × 60 × 4 mm³ after storing for 1000 h in cooling medium (ethylene glycol/water 1/1) in an autoclave at 130° C.
⁴⁾Not measurable, as the sample was destroyed by hydrolytic attack
⁵⁾The bottom weld of a 1 litre bottle was evaluated by the German schools' system of marking: 1 . . . very good, 6 . . . unsatisfactory
⁶⁾Not measurable, as no bottles could be blow moulded from this material
⁷⁾The overall optical impression of the external surface of a 1 litre bottle was evaluated by the German schools' system of marking: 1 . . . very good, 6 . . . unsatisfactory
⁸⁾Gloss measurement according to DIN 67530 1/82 on a section from the side part of an extrusion blow-moulded 1 litre bottle
⁹⁾Not tested, as the hydrolysis resistance was inadequate
¹⁰⁾Measured with a film thickness measuring instrument from Tencol

1. Mixture containing 40 to 89.9 parts by weight of one or more aliphatic polyamides or copolyamides with, 10 to 50 parts by weight of fillers and reinforcing materials, preferably glass fibres, 0.05 to 3 parts by weight of di- or polyfunctional additives with a branching and/or polymer chain extending action, 0.05 to 5 parts by weight of modifier and 0 to 5 parts by weight of other non-branching and non-polymer chain extending additives, the sum of the parts by weight totalling 100.

2. Thermoplastic moulding compositions produced from a mixture according to claim 1.

3. Thermoplastic moulding composition according to claim 2, produced by melt compounding in an extruder.

4. Moulding compositions according to claim 2, wherein copolymers based on acrylates are used as the modifier.

5. Moulding composition according to claim 2, produced by melt compounding.

6. Moulding composition according to one or more of the preceding claims, wherein PA 6,6 is used as the polyamide.

7. Moulding composition according to one or more of the preceding claims, wherein elastomer modifiers of the EPM, EPDM and/or acrylate type are used.

8. Thermoplastic moulding composition according to one or more of the preceding claims, wherein the mixture used contains 60 to 84.9 parts by weight of PA66 with 15 to 39.9 parts by weight of glass fibres, 0.05-2 parts by weight of di- or polyfunctional additives with branching and/or polymer chain extending action, 0.05 to 3 parts by weight of elastomer modifiers and 0 to 5 parts by weight of other additives, the sum of all the parts by weight totalling 100.

9. Use of the moulding compositions according to one or more of the preceding claims for the production of mouldings.

10. Mouldings produced according to one or more of the preceding claims.

11. Mouldings produced according to one or more of the preceding claims by blow moulding.

12. Radiator pipes, radiator headers, expansion tanks and pipes and containers carrying other media, especially motor vehicle air duct pipes and oil circuit pipes and containers, produced according to one or more of the preceding claims.
